(19) United States
(12) Patent Application Publication
(10) Pub. No.: US 2008/0192466 A1
(43) Pub. Date: Aug. 14, 2008

(54) REFLECTIVE LIGHT GUIDING MECHANISM

(75) Inventor: CHENG-HAO CHANG, Jen Te (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tainan County (TW)

(21) Appl. No.: 11/850,618

(22) Filed: Sep. 5, 2007

(30) Foreign Application Priority Data
Feb. 9, 2007 (CN) 200710073267.3

(51) Int. Cl. F21V 7/05

(52) U.S. Cl. 362/235

(57) ABSTRACT

A reflective light guiding mechanism (10) for illuminating a keypad assembly of a portable electronic device is provided. The reflective light guiding mechanism includes a light guiding plate (12), a reflective layer (14), and a plurality of light sources (16). The reflective layer is formed on a surface of the light guiding plate. The reflective layer is made of aluminum, aluminized polyester or their combination. The plurality of light sources is structured and arranged on the reflective layer.

### BACKGROUND OF THE INVENTION

1. Field of the Invention

The present invention relates to light guiding mechanisms and, particularly, relates to a reflective light guiding mechanism.

2. Description of Related Art

Light guiding mechanisms are widely used in many fields, such as LCD monitors, portable electronic devices, advertisement boards, or the like. Light guiding mechanisms are usually used to guide light to an object requiring illumination.

For example, each portable electronic device (e.g., a personal digital assistant (PDA) and a mobile phone) usually includes a keypad assembly. The keypad assembly is required to be illuminating in a certain case, e.g., the portable electronic device is operated in a dark environment. Thus, a light source (e.g., LEDs or light-emitting diodes) and a corresponding light guide mechanism are assembled/mounted with the keypad assembly. Typically, in order to achieve a sound illuminating effect, the light guiding mechanism has a reflective layer formed on the surface thereof. The reflective layer reflects incident light, emitted by the light sources, onto the keypad assembly and thus illuminates the keypad assembly.

However, the typical reflective layer, implemented with the light guide mechanism, is provided with a low degree of reflectivity, i.e., not more than 70 percent. In addition, the typical reflective layer is cost consuming. The present two shortcomings can result in low efficiency of the light guide mechanism.

Therefore, a heretofore-unaddressed need exists in the art to address the aforementioned deficiencies and inadequacies.

### SUMMARY

In one aspect, a reflective light guiding mechanism is provided. The reflective light guiding mechanism includes a light guiding plate, a reflective layer, and a plurality of light sources. The reflective layer is formed on a surface of the light guiding plate. The reflective layer is made of aluminum, aluminized polyester or the combination. The plurality of light sources is structured and arranged on the reflective layer.

In another aspect, a reflective light guiding mechanism for illuminating a keypad assembly of a portable electronic device is provided. The reflective light guiding mechanism includes a light guiding plate, a reflective layer, and a plurality of light sources. The reflective layer is formed on a surface of the light guiding plate. The reflective layer is made of aluminum, aluminized polyester or a combination of the two. The plurality of light sources is structured and arranged on the reflective layer.

Other aspects of the present invention will become more apparent from the following detailed description of the preferred embodiments taken in conjunction with the accompanying drawings, although variations and modifications therein may be affected without departing from the spirit and scope of the novel concepts of the disclosure.

### BRIEF DESCRIPTION OF THE DRAWINGS

Many aspects of a reflective light guiding mechanism can be better understood with reference to the following drawings. These drawings are not necessarily drawn to scale, the emphasis instead being placed upon clearly illustrating the principles of the present reflective light guiding mechanism. Moreover, in the drawings like reference numerals designate corresponding parts throughout the several views. Wherever possible, the same reference numbers are used throughout the drawings to refer to the same or like elements of an embodiment.

FIG. 1 is an isometric view of a reflective light guiding mechanism in accordance with a present embodiment; and

FIG. 2 is a partially, cut-away view of the present reflective light guiding mechanism shown in FIG. 1, taken along line II-II of FIG. 1.

### DETAILED DESCRIPTION OF PREFERRED EMBODIMENTS

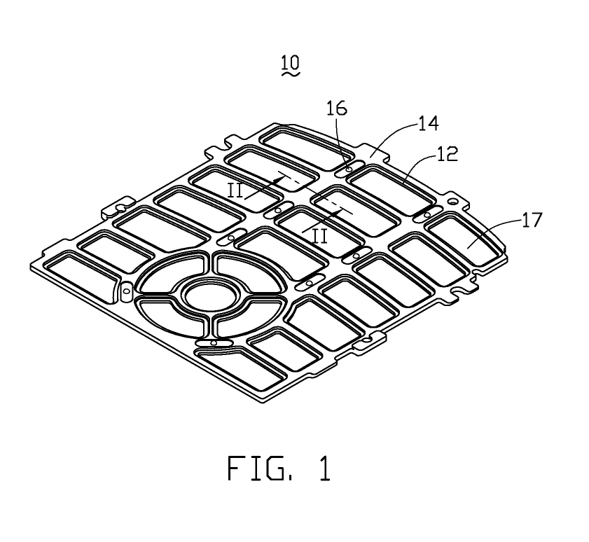

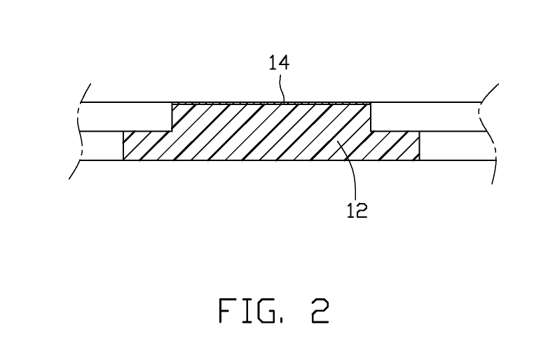

The present reflective light guiding mechanism is described here in conjunction with the accompanying drawings in FIGS. 1-2. The reflective light guiding mechanism is suitable in LCD monitor, portable electronic devices, advertisement board, or the like. The present reflective light guiding mechanism is exemplified to illuminate a keypad assembly of a mobile phone (not shown).

Referring now to FIG. 1, the reflective light guiding mechanism 10 includes a transparent light guiding plate 12, a reflective layer 14, and a plurality of light sources 16 (e.g., LEDs).

The light guiding plate 12 has a plurality of holes 17 defined therethrough. The holes 17 correspond to keys of the keypad assembly of the mobile phone and accommodate the keys therein. The light guiding plate 12 is made of one or more thermoplastic resins selected from a group consisting of PVC (polyvinyl chloride), polycarbonate, polystyrene and the like.

The reflective layer 14 is formed on an upper surface of the light guiding plate 12. The reflective layer 14 can be made of aluminum, aluminized polyester or a combination of the two. Thus, the reflective layer 14 is provided with a high degree of reflectivity, i.e., more than about 90 percent.

The light sources 16 are structured and arranged on the reflective layer 14 and each of the light sources 16 is located between adjacent two of the holes 17.

Each light source 16 of the reflective light guiding mechanism 10 is a point light source. When the reflective layer 14 of the reflective light guiding mechanism 10 reflects the point-source light emitted from the light source 16, the point-source light is transformed into surface-source reflected light. The surface-source reflected light is reflected onto the keypad assembly evenly and accurately. In addition, due to the high degree of reflectivity of the reflective layer 14, the reflective light guiding mechanism 10 can sufficiently guide light to the keypad assembly and thus the keypad assembly is properly illuminated.

Furthermore, the light sources 16 are structured and arranged on the reflective layer 14. In other words, the light sources 16 and the reflective layer 14 are located on essentially the same side of the light guiding plate 12 of the reflective light guiding mechanism 10. Thus, the reflective layer 14 can directly reflect the point-source light emitted from the light source 16. There is no need to include a particular reflecting surface and incident surface with the light guiding plate 12.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A reflective light guiding mechanism, comprising:
a light guiding plate;
a reflective layer formed on a surface of the light guiding plate, the reflective layer being made of aluminum, aluminized polyester or the combination; and
a plurality of light sources being structured and arranged on the reflective layer.

2. The light guiding mechanism as claimed in claim 1, wherein the light guiding plate defines a plurality of holes, each of the plurality of light sources being located between adjacent two of the holes.

3. The light guiding mechanism as claimed in claim 1, wherein the light guiding plate is transparent.

4. The light guiding mechanism as claimed in claim 3, wherein the light guiding plate is made of one or more thermoplastic resins selected from a group consisting of PVC (polyvinyl chloride), polycarbonate and polystyrene.

5. The light guiding mechanism as claimed in claim 1, wherein each of the plurality of the light sources is an LED.

6. A reflective light guiding mechanism for illuminating a keypad assembly of a portable electronic device, comprising:
a light guiding plate;
a reflective layer formed on a surface of the light guiding plate, the reflective layer being made of aluminum, aluminized polyester or the combination thereof; and
a plurality of light sources being structured and arranged on the reflective layer.

7. The light guiding mechanism as claimed in claim 6, wherein the light guiding plate defines a plurality of holes, and the holes respectively accommodate keys of the keypad assembly, and each of the plurality of light sources is located between adjacent two of the holes.

8. The light guiding mechanism as claimed in claim 6, wherein each of the plurality of light sources is an LED.

9. A reflective light guiding mechanism, comprising:
a light guiding plate;
a reflective layer formed on a surface of the light guiding plate; and
a plurality of light sources being structured and arranged on the reflective layer.

10. The light guiding mechanism as claimed in claim 9, wherein the reflective layer is made of aluminum, aluminized polyester or the combination thereof.

11. The light guiding mechanism as claimed in claim 9, wherein the light guiding plate defines a plurality of holes, each of the plurality of light sources being located between adjacent two of the holes.

12. The light guiding mechanism as claimed in claim 9, wherein the light guiding plate is transparent.
